(19) United States
(12) Patent Application Publication
(10) Pub. No.: US 2018/0321747 A1
(43) Pub. Date: Nov. 8, 2018

(54) LINEAR TOUCH-SENSITIVE SWITCH

(71) Applicant: Ching-Hsiung CHU, Taipei (TW)

(72) Inventor: Ching-Hsiung CHU, Taipei (TW)

(21) Appl. No.: 15/587,416

(22) Filed: May 5, 2017

(51) Int. Cl. G06F 3/01; G06F 3/0488; G06F 3/041

(52) U.S. Cl. CPC G06F 3/016; G06F 3/041; G06F 3/04883

(57) ABSTRACT

A linear touch-sensitive switch includes a casing, a circuit unit, and a light-emitting module. The casing has a touched portion and a display portion. The circuit unit has a touch-sensing layer configured to provide multiple sensing modes including first and second sensing modes. The light-emitting module is capable of emitting light according to the multiple sensing modes. The first sensing mode and the second sensing mode respectively perform a multistage switch at a time with a flick gesture, and a stage-by-stage switch with a drag gesture, so as to adjust up or adjust down power of an electrical product to a large degree at once or stage-by-stage.

### BACKGROUND OF THE INVENTION

### 1. Field of the Invention

The present invention relates to a touch-sensitive switch, and particularly to a linear touch-sensitive switch capable of being actuated by any touching spot on a touch surface and indicating a switching state according to different sensing modes.

### 2. Related Art

Generally, a rotary switch is often provided for 3C electronic products, communication devices, or home appliance. The rotary switch is intended to switch a power supply and to adjust the volume of the power supply of an application product so as to modulate operation speed, power, or other functions thereof, for example, rotational speed of a fan, temperature of an air conditioner, volume of a radio, brightness of a light, and a signal strength of a wireless radio. However, the rotary switch takes on a large physical shape that may influence configuration of other components on a same panel. Besides, a conventional rotary switch provides no indication of a controlling state while the rotary switch is being rotated.

In order to improve the above-mentioned drawbacks, more and more conventional switches have been replaced by touch-sensitive switches for at least the reason that configuration of components on a panel is less limited. A linear adjustment switch is known as a sort of touch-sensitive switch and is provided with lighting elements inside for indicating a switching state. Specifically, the lighting elements are capable of lighting in accordance with different touch positions. However, a touch-sensitive mode of a conventional linear touch-sensitive switch is performed by moving finger on a touch surface in a linear direction, whereby the lighting elements emitting light in conjunction with the finger's moving positions in a corresponding linear direction. Furthermore, each time the conventional linear adjustment switch is to be actuated, users are required to put their finger on the touch surface at the position corresponding to the last time the touch surface was being touched, so as to continue the last switching stage and to perform new touch-sensitive control. Undoubtedly, such a touch-sensitive manner is very inconvenient for users. Additionally, if the volume of a conventional linear adjustment switch is to be adjusted from the lowest stage to the highest stage, users have to put their finger on the lowest place of the touch surface and move all the way to the highest place. Again, such a traveling distance surely results in inconvenience of use.

### SUMMARY OF THE INVENTION

Accordingly, an object of the present invention is to provide a linear touch-sensitive switch, which is adapted to an electrical product and is capable of being actuated by a quick flick gesture to perform a multistage switch at a time.

Another object of the present invention is to provide a linear touch-sensitive switch, which is capable of providing light emission according to different sensing modes for indicating a switching state.

To achieve the above-mentioned objects, the linear touch-sensitive switch comprises a casing comprising a touched portion, a display portion located adjacent to the touched portion, and an internal space formed in the casing; a circuit unit disposed in the internal space and electrically connected with a signal cable, the circuit unit comprising a touch-sensing layer located under the touched portion, the touch-sensing layer being configured to provide multiple sensing modes and to generate at least an encoding signal for controlling an electrical product, and the multiple sensing modes including a first sensing mode and a second sensing mode; and a light-emitting module electrically connected to the circuit unit, and comprising a plurality of lighting elements located corresponding to the display portion, the plurality of lighting elements arranged in a linear direction for emitting light according to the multiple sensing modes; wherein the first sensing mode is defined as when a flick gesture is performed and held on any position of the touched portion for a first predetermined period, the touch-sensing layer concurrently generates a signal group containing a plurality of the encoding signals which are transmitted at a time to the electrical product, and wherein the second sensing mode is defined as when a drag gesture is performed and held on any position of the touched portion for a second predetermined period, the touch-sensing layer concurrently generates the one or more encoding signals in response to the drag gesture, where the one or more encoding signals are transmitted one by one in an order of contact positions of the drag gesture on the touched portion, and the second predetermined period is greater than the first predetermined period.

In one aspect of the present invention, the casing further comprises a driving portion formed thereon, the circuit unit further comprises a driving circuit layer located under the driving portion, and when the driving portion is being touched, the driving circuit unit generates an inhibiting signal for inhibiting transmission or for enabling transmission of the at least an encoding signal generated by the touch-sensing layer.

In another aspect of the present invention, a vibrating element is disposed in the internal space and electrically connected to the circuit unit, and the vibrating element is capable of providing a first vibrating mode and a second vibrating mode respectively in response to the first sensing mode and the second sensing mode.

The linear touch-sensitive switch of the present invention utilizes the first and second sensing modes to respectively perform a multistage switch at a time with a flick gesture, and a stage-by-stage switch with a drag gesture, so as to adjust up or adjust down power of an electrical product to a large degree at once or stage-by-stage, whereby efficiently overcoming the drawbacks of the traditional linear switches that merely provide a stage-by-stage switch and are required to follow the last touch position for each touch-sensitive control.

### BRIEF DESCRIPTION OF THE DRAWINGS

FIG. 1 is a perspective assembly view of a linear touch-sensitive switch of the present invention;

FIG. 2 is an exploded view of FIG. 1;

FIG. 3 is a schematic bottom, perspective view of the linear touch-sensitive switch with a lower cover removed;

FIG. 4 is a top plan view of FIG. 1;

FIG. 5 is schematic cross-sectional view taken along line A-A of FIG. 4; and

FIG. 6 is a schematic functional block diagram of the linear touch-sensitive switch of the present invention.

### DESCRIPTION OF THE PREFERRED EMBODIMENTS

The present invention discloses a linear touch-sensitive switch 1 being adapted to electrical products, electric appliance, or illumination devices for adjusting volume of sound or brightness and enabling fine and multistage performance. The linear touch-sensitive switch 1 is being actuated with a touch body (not shown), which is exemplified by a user's finger or a stylus pen.

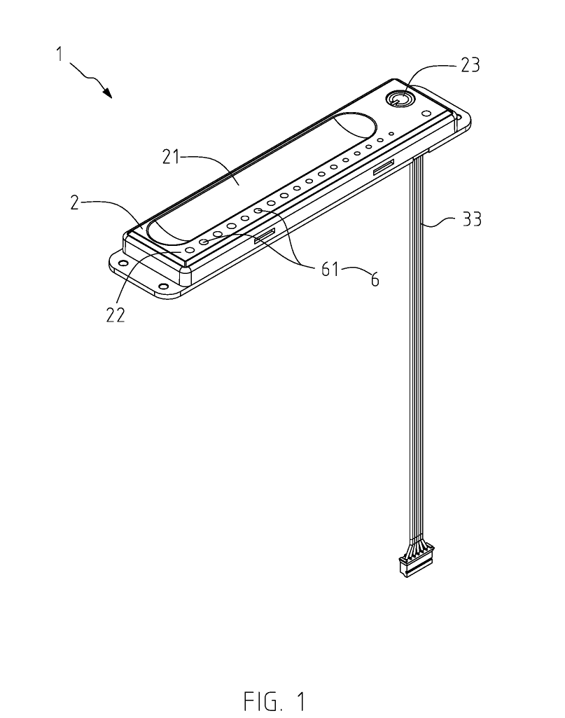

Referring to FIGS. 1 to 3 illustrating a preferred embodiment of the present invention, the linear touch-sensitive switch 1 comprises a casing 2, a circuit unit 3, a vibrating element 4, and a light-emitting module 6. The casing 2 has a rectangular shape including an upper cover 201 assembled with a lower cover 202, and forming an internal space 20 therein. Specifically, the casing 2 comprises a touched portion 21, a display portion 22, and a driving portion 23 formed on the upper cover 201. The display portion 22 is located adjacent to the touched portion 21, and the driving portion 23 is located at one end of the upper cover 201. In this embodiment, the touched portion 21 further protrudes inward of the internal space 20 to be concave for guiding the touch body to move on the touched portion 21.

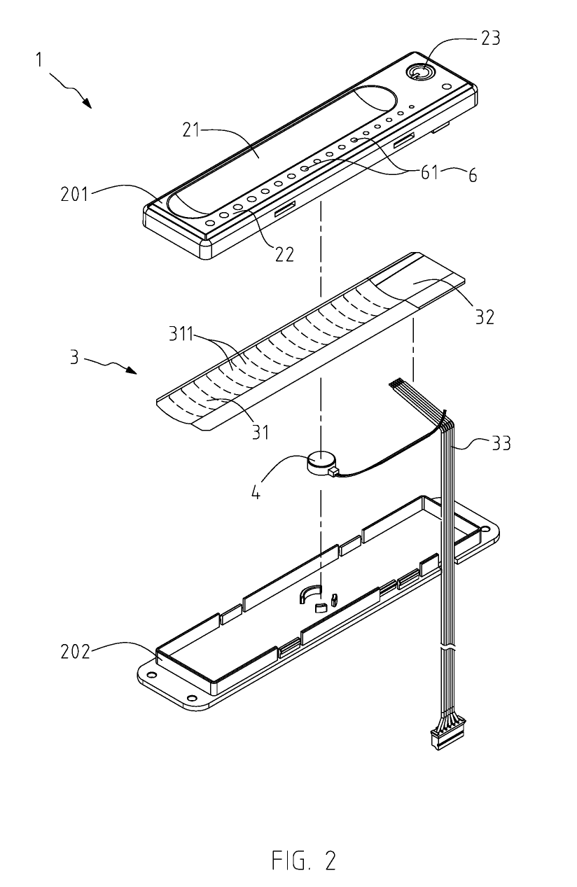

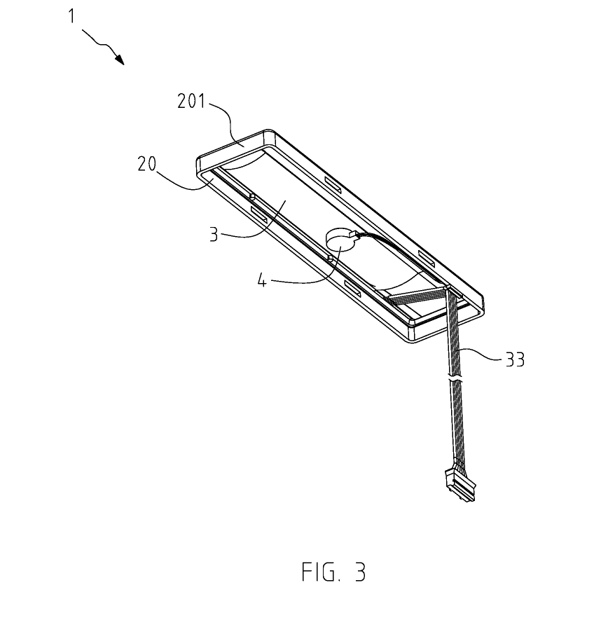

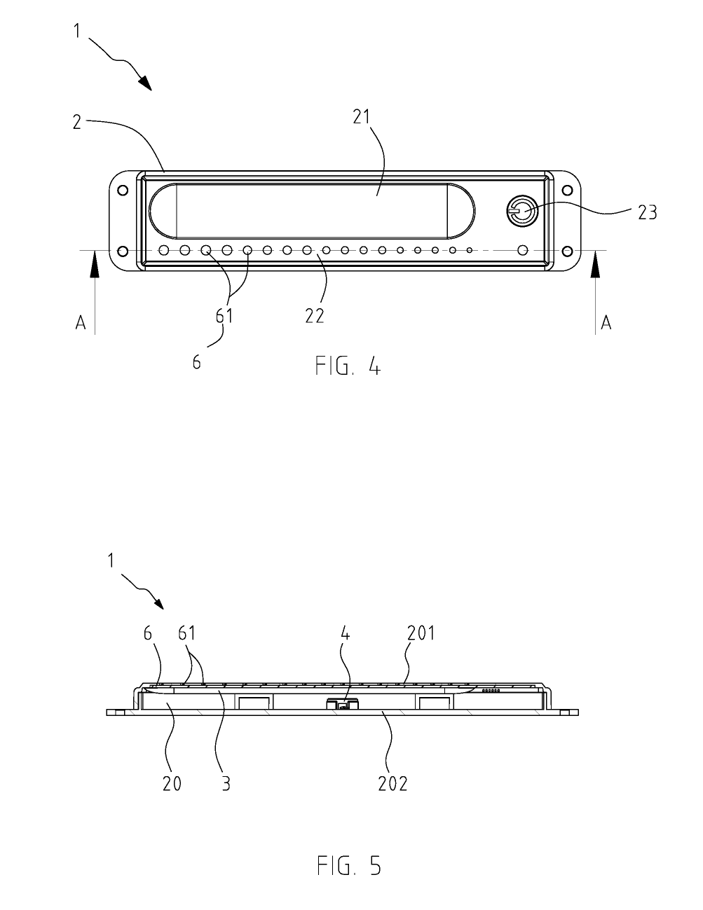

The circuit unit 3 is disposed in the internal space 20 as shown in FIG. 3. Specifically, the circuit unit 3 is a flexible printed circuit board electrically connected with a signal cable 33 of which one end is connected to an electrical product (no shown). As shown in FIG. 2, the circuit unit 3 comprises a touch-sensing layer 31 and a driving circuit layer 32. The touch-sensing layer 31 is located under the touched portion 21 and is configured to provide multiple sensing modes 5 and to generate at least an encoding signal for controlling the electrical product. Particularly, the touch-sensing layer 31 has a length corresponding to that of the touched portion 21 so as to be capable of sensing all the touching positions on the touched portion 21. The driving circuit layer 32 is located under the driving portion 23.

The light-emitting module 6 is disposed in the internal space 20 and electrically connected to the circuit unit 3. The light-emitting module 6 comprises a plurality of lighting elements 61 which are located corresponding to the display portion 22 of the casing 2 and arranged in a linear direction in parallel with the touched portion 21. The plurality of lighting elements 61 are capable of emitting light in different lighting modes according to the multiple sensing modes 5, wherein the light emitted by the lighting elements is visible from the display portion 22. In the preferred embodiment, the lighting elements 61 are light emitting diodes.

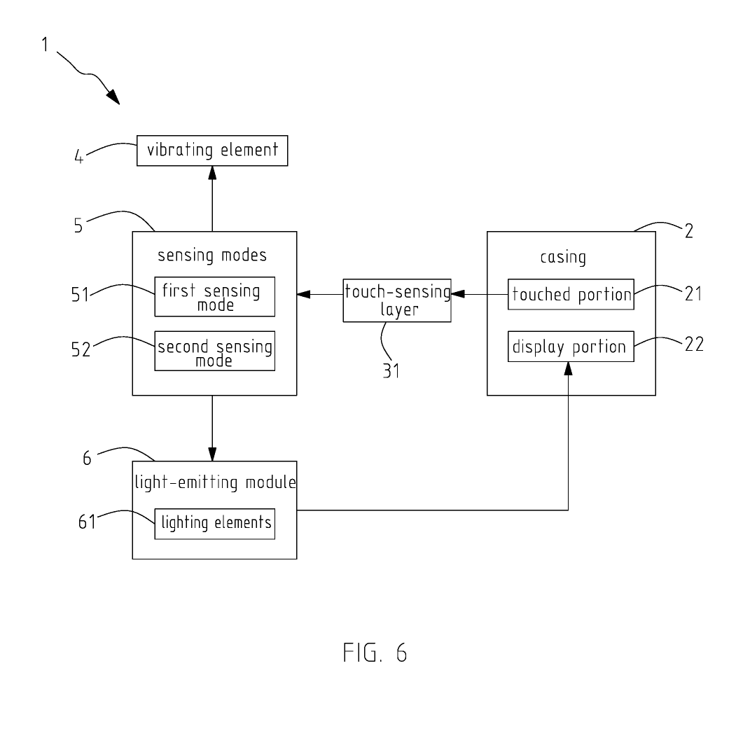

In particular, as shown in FIG. 2, the touch-sensing layer 31 is configured with a plurality of sensing sections 311 arranged in parallel with each other in the linear direction facing the touched portion 21. The multiple sensing modes 5 include a first sensing mode 51 and a second sensing mode 52 (as shown in FIG. 6). The first sensing mode 51 is defined as when a flick gesture is performed and held on any position of the concave touched portion 21 for a first predetermined period, the touch-sensing layer 31 concurrently generates a signal group containing a plurality of the encoding signals which are transmitted all together at a time to the electrical product. In the preferred embodiment, the flick gesture is performed with a user's finger, and the first predetermined period is equal to or smaller than 0.5 second. In one embodiment, the linear touch-sensitive switch 1 is adapted to a lamp (not shown), and the number of the encoding signals contained in the signal group is four. Specifically, as the switch 1 is actuated under the first sensing mode 51, brightness of the lamp is being increasingly or decreasingly adjusted with four stages of power at a time, whereby achieving the objective of multistage switching at a time. In this manner, there is no need to move the finger on the touched portion 21 in a longer distance for a multistage switch.

Unlike the first sensing mode 51, the second sensing mode 52 is defined as when a drag gesture is performed and held on any position of the touched portion 21 for a second predetermined period, the touch-sensing layer 31 concurrently generates the one or more encoding signals in response to the drag gesture, where the one or more encoding signals are transmitted one by one in an order of contact positions of the drag gesture on the touched portion 21. The second predetermined period is greater than 0.5 second and the first predetermined period. Likewise, as the linear touch-sensitive switch 1 is adapted to a lamp and is actuated under the second sensing mode 52, brightness of the lamp is capable of being adjusted gradually. More specifically, in case that the linear touch-sensitive switch 1 is in a state that a third sensing section 311 is the last section in response to the finish position of the last drag gesture, users can touch any position on the touched portion 21 to perform the multiple sensing modes 5 without having to follow the last section for triggering a next adjustment. If the drag gesture of the second sensing mode 52 is performed by traveling a distance corresponding to three sensing sections 311, the touch-sensing layer 31 correspondingly generates three encoding signals one by one, so as to adjust the power of the electrical product from the third stage to the sixth stage gradually, whereby brightness of the lamp is increased stage by stage.

As distinct from a traditional rotary switch, an electrical product used with the linear touch-sensitive switch 1 of the present invention is allowed to accept a predetermined maximum power supply which is divided into a plurality of segment values as designed. For example, if an electrical product is an electronic lighting device (not shown) and operates at a maximum power supply of 60 watt, then, based on a practical application, the maximum power supply of 60 watt can be configured to be divided into 10 segment values. More specifically, each touch-sensitive control of the flick gesture is capable of readily adjusting multiple segment values of the electronic lighting device at a time for increasing or decreasing the brightness to a large degree at once. Furthermore, each touch-sensitive control of the drag gesture is capable of reaching one or more of the segment values one by one according to dragging distance in a linear direction on the touched portion 21, so as to gradually adjust up or adjust down the brightness.

Furthermore, each of signals coded by the linear touch-sensitive switch 1 is in a format of pulse width modulation (PWM) for activating the power supply or/and increasingly boosting a power supply of an external power source, or the signals being coded are intended to decreasingly lower or deactivate the power supply. As a result, the linear touch-sensitive switch 1 is capable of controlling an electrical product more precisely than a traditional mechanical rotary switch.

Referring to FIGS. 1 and 2, the linear touch-sensitive switch 1 further provides a function of inhibiting signal transmission of the first sensing mode 51 and the second sensing mode 52 for preventing the switch from being mistakenly actuated. Specifically, when the driving portion 23 is being touched, the driving circuit unit 32 generates an inhibiting signal for inhibiting transmission or for enabling transmission of the signal group or the one or more encoding signals generated by the touch-sensing layer 31. In other words, when the driving portion 23 is being touched first, and then users perform the flick gesture or the drug gesture on the touched portion 21, the signal transmission is being inhibited, and the linear touch-sensitive switch 1 is not to be actuated until the driving portion 23 is being touched again to enable the signal transmission.

Particularly, in the preferable embodiment, each of the plurality of lighting elements 61 represents a switch stage. Under the first sensing mode 51, a predetermined number of the lighting elements 61 concurrently emit light as the signal group containing a plurality of the encoding signals is transmitted. Likewise, under the second sensing mode 52, one or more of the lighting elements 61 emit light one by one in the order of the contact positions of the drag gesture on the touched portion 21 as the one or more encoding signals are transmitted. The purpose of light emission from the light-emitting module 6 is to indicate a switch state of the switch of the present invention, so as to help users recognize whether the first sensing mode 51 or the second sensing mode 52 is exactly performed. It is noted that any position of the touched portion 21 can be touched to perform the first and second sensing modes 51 and 52, and the lighting elements 61 emit light correspondingly.

In order to further help users to recognize a switch state of the switch, a vibrating element 4 is disposed in the internal space 20 and electrically connected to the circuit unit 3. The vibrating element 4 is capable of providing a first vibrating mode and a second vibrating mode respectively in response to the first sensing mode 51 and the second sensing mode 52, wherein the strength of the first vibrating mode is greater than that of the second vibrating mode. In addition, under the second sensing mode 52, the strength of the second vibrating mode is turning stronger as to adjust up the switch 1; likewise, the strength of the second vibrating mode is turning weaker as to adjust down the switch 1.

It is understood that the invention may be embodied in other forms within the scope of the claims. Thus the present examples and embodiments are to be considered in all respects as illustrative, and not restrictive, of the invention defined by the claims.

What is claimed is:

1. A linear touch-sensitive switch, comprising:
a casing comprising a touched portion, a display portion located adjacent to the touched portion, and an internal space formed in the casing;
a circuit unit disposed in the internal space and electrically connected with a signal cable, the circuit unit comprising a touch-sensing layer located under the touched portion, the touch-sensing layer being configured to provide multiple sensing modes and to generate at least an encoding signal for controlling an electrical product, and the multiple sensing modes including a first sensing mode and a second sensing mode; and
a light-emitting module electrically connected to the circuit unit, and comprising a plurality of lighting elements located corresponding to the display portion, the plurality of lighting elements arranged in a linear direction for emitting light according to the multiple sensing modes;
wherein the first sensing mode is defined as when a flick gesture is performed and held on any position of the touched portion for a first predetermined period, the touch-sensing layer concurrently generates a signal group containing a plurality of the encoding signals which are transmitted at a time to the electrical product, and wherein the second sensing mode is defined as when a drag gesture is performed and held on any position of the touched portion for a second predetermined period, the touch-sensing layer concurrently generates the one or more encoding signals in response to the drag gesture, where the one or more encoding signals are transmitted one by one in an order of contact positions of the drag gesture on the touched portion, and the second predetermined period is greater than the first predetermined period.

2. The linear touch-sensitive switch of claim 1, wherein a predetermined number of the lighting elements concurrently emit light as the signal group containing a plurality of the encoding signals is transmitted.

3. The linear touch-sensitive switch of claim 1, wherein one or more of the lighting elements emits light one by one in the order of the contact positions of the drag gesture on the touched portion as the one or more encoding signals are transmitted.

4. The linear touch-sensitive switch of claim 1, wherein the casing further comprises a driving portion formed thereon, the circuit unit further comprises a driving circuit layer located under the driving portion, and when the driving portion is being touched, the driving circuit unit generates an inhibiting signal for inhibiting transmission or for enabling transmission of the at least an encoding signal generated by the touch-sensing layer.

5. The linear touch-sensitive switch of claim 1, wherein a vibrating element is disposed in the internal space and electrically connected to the circuit unit, and the vibrating element is capable of providing a first vibrating mode and a second vibrating mode respectively in response to the first sensing mode and the second sensing mode.

6. The linear touch-sensitive switch of claim 5, wherein the strength of the first vibrating mode is greater than that of the second vibrating mode.

7. The linear touch-sensitive switch of claim 1, wherein the flick gesture and the drag gesture are capable of being performed with a touch body, and the touched portion of the casing further protrudes inward of the internal space for guiding the touch body to move on the touched portion.

8. The linear touch-sensitive switch of claim 1, wherein the first predetermined period of the first sensing mode is equal to or smaller than 0.5 second.
